(19) United States
(12) Patent Application Publication
(10) Pub. No.: US 2026/0233550 A1
(43) Pub. Date: Aug. 13, 2026

(54) COVERT MACHINE-READABLE MICRO-OPTIC FEATURE EMBEDDED IN LENS LAYER

(71) Applicant: Crane & Co., Inc., Dalton, MA (US)

(72) Inventors: Hayden Johnson, Atlanta, GA (US); Brian Walsh, Norcross, GA (US); Nancy J. Gettens, Waban, MA (US)

(21) Appl. No.: 19/164,171

(22) PCT Filed: Dec. 29, 2023
(86) PCT No.: PCT/US2023/086540

§ 371 Date: Sep. 10, 2025

Related U.S. Application Data
(60) Provisional application No. 63/489,738, filed on Mar. 10, 2023.

(51) Int. Cl. B42D 25/351; B42D 25/21; B42D 25/22; B42D 25/305; B42D 25/324; B42D 25/382

(52) U.S. Cl. CPC B42D 25/351; B42D 25/21; B42D 25/22; B42D 25/305; B42D 25/324; B42D 25/382

(57) ABSTRACT

A micro-optic device includes an optical spacer having a first side and a second side, an icon layer comprising a plurality of image icons of a first color disposed on the first side of the optical spacer, and a focusing layer comprising a plurality of refractive focusing elements disposed on the second side of the optical spacer. The plurality of refractive focusing elements project a synthetically magnified image of the plurality of image icons, and image icons of the first color project a component of the synthetically magnified image that is of the first color. Additionally, the refractive focusing elements are doped with a machine readable taggant which emits a characteristic signal at a first frequency in the ultraviolet spectrum.

### CROSS-REFERENCE TO RELATED APPLICATIONS

This application is a 371 National Stage of International Application No. PCT/US2023/086540, filed Dec. 29, 2023, which claims priority to U.S. Provisional Patent Application No. 63/489,738, filed Mar. 10, 2023, the disclosures of which are incorporated herein by reference.

### TECHNICAL FIELD

The present disclosure relates to enhancing the counterfeit resistance of secure documents, such as currency notes, passports and other documents comprising surface-applied micro-optic security devices. More specifically, this disclosure to the provision of a machine-readable feature embedded within a lens layer of a micro-optic device to provide enhanced detectability and consistent signal strength at a machine reader.

### BACKGROUND

Hardening passports, banknotes, and other documents (referred to herein as “security documents”) whose constructional features include hard-to-reproduce indicia of the documents' authenticity against counterfeiting remains an ongoing source of technical challenges and opportunities for improvement in the field of security document design. More specifically, security document designers and designers of hard-to-reproduce security features (for example, to balance a host of competing technical and practical objectives, including, without limitation, optical performance requirements (for example, that the system provide a bright, clearly visible optically variable effect, thereby improving user engagement and visible indicia of authenticity), machine-readability requirements (for example, that the system have one or more latent features whose absence or presence can be reliably detected with specialized equipment), and manufacturing objectives (for example, that systems which achieve the optical performance and machine-readability requirements can be produced using industry-standard machinery).

Implementation of machine-readability and providing a clear synthetic image provide one specific example of the technical challenges presented by competing and frequently mutually exclusive design objectives. Many micro-optic devices which project a synthetic image through the coordinated magnification of content in an icon layer through an array of focusing elements (for example, lenses or reflectors) utilize some variation on a three-layer structure with an icon layer comprising the bottom layer, an optical spacer (for example, a section of clear material of appropriate thickness to put the icon layer within the focal plane of a focusing layer), and the focusing layer. Typically, such micro-optic devices are attached to a substrate (for example, a sheet of currency paper) icon-side down, such that the adhesive holding the device to the substrate is disposed on the underside (furthest away from the focusing elements) of the icon layer, and the focusing layer is on the exterior (i.e., closest to the viewer) of the security document. Where a machine-readable (“MR”) feature is provided in micro-optic systems so constructed, the norm is to embed the MR feature below the icon layer (for example, in an opacifying “camo coat” of white or light-colored pigment), or alternatively, to embed the MR feature material in or around the material of the icon layer. Such approaches, which bury the MR-component below the spacer and the focusing layer trade optical performance for machine readability, in that while the MR-component is situated at a point where it has little to no effect on the system's ability to project a synthetic image, the signal provided by the MR-component can be attenuated or distorted by passing back through the optical spacer and focusing layers enroute to reading apparatus outside of the security document.

Alternatively, positioning the MR-component in a higher layer of the security device, such as in the focusing layer or optical spacer generally improves machine-readability, but can degrade optical performance, in that many MR-components are either pigmented (and thus can visibly interfere with images projected by the system), or affect the focusing properties of the focusing layer (for example, by changing the refractive indices of the lens material).

While for many applications, such as the very, very thin micro-optic devices (for example, having a device thickness of 50 microns or less) used as indicia of authenticity on certain banknotes, the attenuation in signal is manageable, in other applications, such as the thicker, more inexpensively produced micro-optic security devices used on consumer products (for example, hard-to-reproduce indicia of authenticity used on product labels for Swiss watches or French wines), the attenuation effect can be significantly more pronounced.

Thus, optimizing both machine readability and image clarity in micro-optic systems which utilize a focusing layer remains a source of technical challenges and opportunities for improvement in the art.

### SUMMARY

The present disclosure illustrates embodiments of a wet-harvest resistant embossed security device and methods for making same.

In a first embodiment, a method includes providing an optical spacer having a first side and a second side, forming an icon layer comprising a plurality of image icons of a first color on the first side of the optical spacer; and forming a focusing layer comprising a plurality of refractive focusing elements on the second side of the optical spacer, wherein the plurality of refractive focusing elements project a synthetically magnified image of the plurality of image icons, wherein image icons of the first color project a component of the synthetically magnified image that is of the first color, and wherein refractive focusing elements of the plurality of refractive focusing elements are doped with a machine readable taggant which emits a characteristic signal at a first frequency in the ultraviolet spectrum.

In a second embodiment, micro-optic devices which include an optical spacer having a first side and a second side, an icon layer comprising a plurality of image icons of a first color disposed on the first side of the optical spacer, and a focusing layer comprising a plurality of refractive focusing elements disposed on the second side of the optical spacer. The plurality of refractive focusing elements project a synthetically magnified image of the plurality of image icons, and image icons of the first color project a component of the synthetically magnified image that is of the first color. Additionally, the refractive focusing elements are doped with a machine readable taggant which emits a characteristic signal at a first frequency in the ultraviolet spectrum.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a machine readable micro-optic device according to various embodiments of this disclosure; and

FIG. 2 illustrates operations of an example method for making a device according to various embodiments of this disclosure.

### DETAILED DESCRIPTION

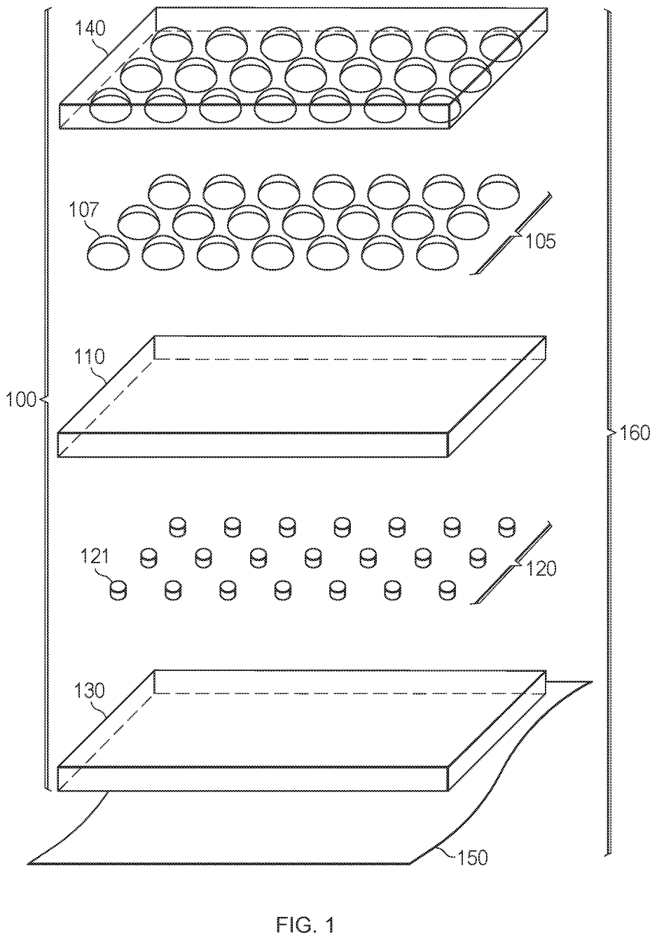

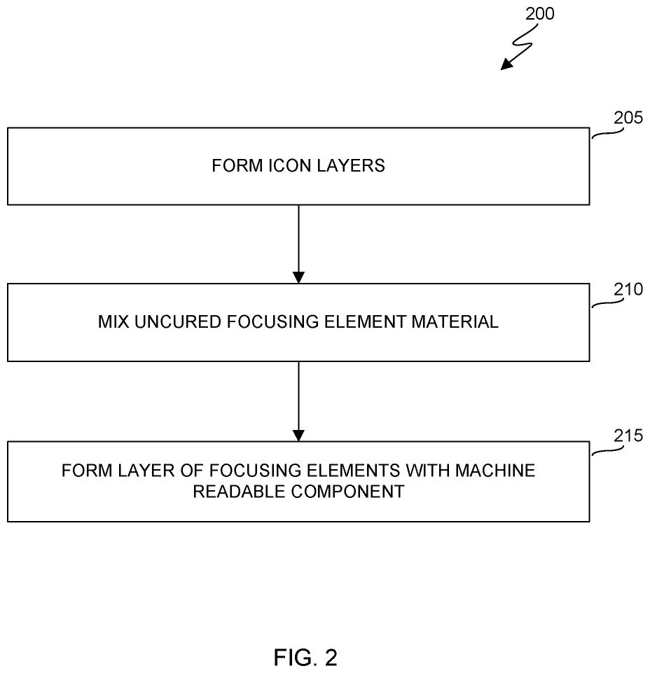

FIGS. 1 through 2, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged security document.

Although the present disclosure has been described with various embodiments, various changes and modifications may be suggested to one skilled in the art. It is intended that the present disclosure encompass such changes and modifications as falling within the scope of the claims.

FIG. 1 illustrates an example of a machine-readable optical security device 100, which is incorporated in a security document 160, according to certain embodiments of this disclosure.

Referring to the non-limiting example of FIG. 1, optical security device 100 comprises a plurality of focusing elements 105 (including, for example, focusing element 107), and an arrangement of image icons 120 (including, for example, image icon 121). According to various embodiments, each focusing element of plurality of focusing elements 105 has a footprint, in which one or more image icons of arrangement of image icons 120 is positioned. Collectively, the focusing elements of plurality of focusing elements 105, magnify portions of image icons 120 to produce a magnification effect (also referred to as a “synthetically magnified image” or more briefly, a “synthetic image”) wherein the individually microscopic image icons are collectively magnified by the plurality of focusing elements 105 to produce an image which dynamically reacts (for example, by appearing to move, or change colors) in response to shifts in viewing angle. Given the small scale and tight manufacturing tolerances of the constituent structures of the optical security device providing the synthetic magnification effect, many malicious actors are not able to produce counterfeit versions of optical security device 100. Accordingly, optical security device 100 is, in many cases, a trusted visual indicium of a security document's (for example, security document 160) authenticity.

According to certain embodiments, plurality of focusing elements 105 comprises a planar array of micro-optic focusing elements. In some embodiments, the focusing elements of plurality of focusing elements 105 comprise micro-optic refractive focusing elements (for example, plano-convex or GRIN lenses). Refractive focusing elements of plurality of focusing elements 105 are, in some embodiments, produced from light cured resins with indices of refraction ranging from 1.35 to 1.7, and have diameters ranging from 5 μm to 200 μm. In various embodiments, the focusing elements of plurality of focusing elements 105 comprise reflective focusing elements (for example, very small concave mirrors), with diameters ranging from 5 μm to 50 μm. While in this illustrative example, the focusing elements of plurality of focusing elements 105 are shown as comprising circular plano-convex lenses, other refractive lens geometries, for example, lenticular lenses, are possible and within the contemplated scope of this disclosure. Materials suitable for forming plurality of focusing elements 105 include, without limitation, substantially transparent, colored or colorless polymers such as acrylics, acrylated polyesters, acrylated urethanes, epoxies, polycarbonates, polypropylenes, and the like. Various methods of providing the layer of focusing elements can include extrusion, radiation cured casting, injection molding, reaction injection molding or reaction casting.

The focusing elements of plurality of focusing elements 105 (both reflectors and refractive lenses) can be characterized by an F #, which may be adjusted as desired to modify the synthetic image and its optical effect. Suitable F numbers, in view of the desired thickness of the security film or security device, can be adjusted to be less than 10, or in some embodiments less than about 4, or in some embodiments, less than 2 or 1. The synthetic image can also be modulated by the relative arrangements and alignments of the array of focusing elements to the array of image elements and each array has respective repeat periods. The repeat periods of the respective arrays may be adjusted such that their ratios are equal to 1, slightly above or slightly below 1; though ratios substantially above and substantially below 1 are also contemplated. Base diameters (equivalent to base widths for cylindrical lenses) of the focusing elements may also be adjusted as desired and it is within the scope of the present disclosure that these base diameters could have ranges of 200 μm to 500 μm; 50 μm to 200 μm; less than 50 μm (such as less than about 45 μm or ranging from about 10 μm to about 40 μm). The focusing elements may further be modified by adjusting the focal lengths such that the focal lengths allow for image elements in the array of image elements to be viewed through the focusing element and project a synthetic image. Focal lengths of less than 50 μm are suitable, such as less than 45 μm, such as ranging from about 10 μm to about 30 μm.

Additionally, the cured light-curable material (for example, polyacrylate resin) from which plurality of focusing elements 105 are formed may contain particles or molecules of a machine-readable taggant or additive. As used in this disclosure, the term “machine-readable” encompasses materials or arrangements of materials which exhibit one or more properties which are latent to the human eye in daylight, but which become visibly apparent or detectable under conditions provided by a machine. Examples of machine-readability include, without limitation, up-conversion (where a particle receives light energy at a first wavelength and emits light at a second wavelength that is shorter than the first wavelength). Other examples of machine-readable additives include magnetically readable compounds.

As shown in the illustrative example of FIG. 1, arrangement of image icons 120 comprises a set of image icons (including image icon 121), positioned at predetermined locations within the footprints of the focusing elements of plurality of focusing elements 105. According to various embodiments, the individual image icons of arrangement of image icons 120 comprise regions of light cured material associated with the focal path of structured light (for example, collimated UV light) passing through plurality of focusing elements 105 from a projection point associated with one or more predetermined ranges of viewing angles. In some embodiments, the individual image icons of arrangement of image icons 120 are not provided within a structured image icon layer. As used in this disclosure, the term “structured image layer” encompasses a layer of material (for example, a light-curable resin) which has been embossed, or otherwise formed to comprise structures (for example, recesses, posts, grooves, or mesas) for positioning and retaining image icon material. According to various embodiments, the individual image icons of arrangement of image icons 120 are provided within a structured image layer, the structured image layer comprising one or more of voids, mesas, or posts, which act as retaining structures to hold micro-and nano-scale volumes of colored material. In some embodiments, arrangement of image icons 120 comprises icons of a single color. In other embodiments, image icons of arrangement of image icons 120 comprise icons of two or more colors.

While not shown in FIG. 1, in certain embodiments, the relief structures of the icon layer, rather than contrasting interstitial material retained within the embossed relief structures may operate as the image icons. In such embodiments, the embossed material may be pigmented and semi-opaque, and the variances in thickness of the relief structures may create points of contrast which can be projected through plurality of focusing elements 105 to provide a synthetic image.

As shown in the illustrative example of FIG. 1, in certain embodiments, optical security device 100 includes an optical spacer 110. According to various embodiments, optical spacer 110 comprises a film of substantially transparent material which operates to position image icons of arrangement of image icons 120 in or around the focal plane of focusing elements of plurality of focusing elements 105. In certain embodiments according to this disclosure, optical spacer 110 comprises a manufacturing substrate upon which one or more layers of light curable material can be applied, to form one or more of arrangement of image icons 120 or plurality of focusing elements 105.

According to various embodiments, optical security device 100 comprises one or more regions of light-cured protective material which occupy the spaces between the image icons of arrangement of image icons 120. In some embodiments, the arrangement of image icons 120 is first formed (for example, by selectively curing and removing liquid light-curable material on optical spacer 110), and then a layer of clear, light-curable material is applied to fill spaces between the image icons of arrangement of image icons 120 and then flood-cured to create a protective layer, which protects the image icons from being moved from their positions within the footprints of focusing elements of plurality of focusing elements 105. In certain embodiments, the light-curable material used to form arrangement of image icons 120 is a pigmented, ultraviolet (UV)-curable polymer.

In some embodiments, arrangement of image icons 120 is affixed to a second substrate 130, which operates to protect and secure arrangement of image icons 120 and provide an interface for attaching optical security device 100 to a substrate 150 as part of security document 160. In some embodiments, optical security device 100 is affixed to substrate 150 during the manufacture of substrate in a paper-making machine, such as a Fourdrinier machine. According to some embodiments, optical security device 100 is affixed to substrate 150 by a layer of adhesive between arrangement of image icons 120 and a top surface of substrate 150.

In certain embodiments according to this disclosure, optical security device 100 comprises a seal layer 140. According to certain embodiments, seal layer 140 comprises a thin (for example, a 2 μm to 50 μm thick) layer of substantially clear material which interfaces on a lower surface, with focusing elements of the plurality of focusing elements 105 and comprises an upper surface with less variation in curvature (for example, by being smooth, or by having a surface whose local undulations are of a larger radius of curvature than the focusing elements) than the plurality of focusing elements 105. According to various embodiments, the upper surface of seal layer 140 is formed from a thermoplastic material which can be ultrasonically welded to a surface comprising a cellulosic material.

As shown in the non-limiting example of FIG. 1, in certain embodiments, optical security device 100 can be attached to substrate 150, to form a security document 160. According to various embodiments, substrate 150 comprises a sheet of material with at least one surface comprising cellulosic material, such as wood pulp, cotton fiber, linen fiber, flax fiber, sisal fiber, hemp fiber, Abaca fiber, Kozo fiber, Mitsumata fiber, bamboo fiber or Kenaf fiber. In some embodiments, substrate 150 is a blend of cotton and linen fibers, such as used for U.S. banknotes. For example, substrate 150 may be made of a fiber blend which contains between 65-80% cotton fibers and between 20-35% linen fibers. In some embodiments, the relative proportions of cotton and linen fibers may be such that the substrate contains 65-100% cotton fibers and between 0 to 35% linen fibers.

While FIG. 1 provides one example of an optical security device 100 according to various embodiments, the present disclosure is not so limited. Other optical security devices which comprise at least one surface with a thermoplastic polymer and include hard-to-reproduce micro-and nano-scale optical structures (for example, holograms, devices providing thin-film effects, devices producing diffraction-based optical effects) which have embedded machine-readable features which do not affect the optical properties of transparent layers above the icon layer are within the contemplated scope of this disclosure. Additionally, certain embodiments according to this disclosure may include structures not explicitly shown in FIG. 1, such as a contrast or “camo” coat of opacifying material applied to enhance the contrast of icon layer 120. In some embodiments, the contrasting material can be a thin layer of white or light-colored pigment. Alternatively, the contrast coat may be a layer of a reflective material, such as aluminum, zinc, or copper.

FIG. 2 describes operations of an example method for creating a machine-readable micro-optic security device according to various embodiments of this disclosure. It should be noted that the operations described with reference to FIG. 2 do not necessarily need to be performed in the order described, and that, depending on the manufacturing process utilized, certain operations may be omitted or performed in a different sequence. As one illustrative example, in a thin, spacer-micro-optic system, steps relating to providing an optical spacer may be omitted. As a further illustrative example, the icon structures may be formed through directional curing, wherein a curing light is passed through the layer of focusing elements on one side of the device to form icon structures comprise regions of cured, pigmented material on an opposing side of the device.

Referring to the illustrative example of FIG. 2, at operation 205, an icon layer (for example, icon layer 120 in FIG. 1) is formed on one side of an optical spacer (for example, optical spacer 110 in FIG. 1). In certain embodiments, the icon layer is formed by cast-curing, wherein an initial smooth layer of clear or substantially colorless radiation-curable resin (for example, a polyacrylate) is laid down on the optical spacer at a uniform thickness (such as with a Mayer rod), and then embossed with one or more tools with a relief pattern defining a set of retaining structures for colored material in the resin layer. This initial layer of embossed uncured material is then radiation cured (for example, by flooding the embossed material with ultraviolet light or other form of radiation for causing the resin to cure and cross-link). In some embodiments, uncured pigmented light curable material of a first color is subsequently applied to at least part of the micro-optic structure such that the uncured material fills retaining structures formed by the embossing tool. The uncured pigmented light curable material of the first color is then exposed to curing radiation (for example, ultraviolet light) and excess, uncured pigmented material is bladed off of the retaining structures. Depending on whether multiple colors are being utilized in the icon layer, multiple iterations of filling and curing of pigmented materials may be performed. Additionally, in some embodiments, the pigmented material may be applied and cured zonally, with only portions of the device receiving pigmented material and curing light. According to some embodiments, this approach can produce tightly registered multi-color patterns of icon structures, while avoiding image degradation associated with blading causing uncured pigmented material to “smear” across the icon layer.

In some embodiments, rather than filling the negative spaces (i.e., wells) created in the icon layer by the embossing tool with pigmented material, pigmented material may instead be applied to the positive regions (i.e., mesas) formed by the embossing tool and then cured. In such embodiments, the step of blading the icon layer as part of operation 205 may be avoided.

As shown in FIG. 2, at operation 210, the uncured resin for the array of focusing elements (for example, array of focusing elements 105 in FIG. 1) is doped with one or more compounds which provide machine-readability, and, at the same time, can be provided at concentrations which do not affect the native optical properties of the material used to form the array of focusing elements, and, at the same time, provide a reliable machine response. According to various embodiments, a volume of uncured acrylate resin is doped with an up-converting taggant (for example, Lumilux MRG-100 by Honeywell corporation) at a concentration of 0.1 to 0.6% of the weight of the total mixture. As used in this disclosure, the expression “up-convert” refers to chemicals which absorb light energy in a first frequency range and emit light energy at a second, higher, frequency range. In the case of Lumilux, this up-converter absorbs light in the infrared portion of the EV spectrum and emits light in the ultraviolet portion of the spectrum. According to certain embodiments, the machine-readable taggant is provided as a suspension within the radiation-curable lens material and is kept suspended within the uncured lens material through the addition of a surfactant at the time the lens material is doped with the machine-readable compound.

Skilled artisans will appreciate that Lumilux comprises but one, non-limiting example of a machine-readable additive which can be provided to uncured lens material according to various embodiments of this disclosure. Other additives, such as strontium-aluminum based pigments, can also be used at similar concentrations to dope the uncured lens material with similar results.

Referring to the illustrative example of FIG. 2, at operation 215, the layer of focusing elements (for example, focusing layer 105 in FIG. 1) is formed. According to various embodiments, the focusing layer is formed by applying a layer of the uncured lens material created at operation 210 (for example, by spreading a layer of consistent thickness with a Mayer rod) across an opposing side of the optical substrate from the side with the icon layer, and embossing the uncured material to create a relief structure which provides a curved interface between the lens material and a material of dissimilar refractive index (RI). In some embodiments, the material of dissimilar refractive index is the air, and the relief structure forms a plurality of convex lenses. In some embodiments, the dissimilar material of dissimilar refractive index is a seal layer (for example, seal layer 140 in FIG. 1). In embodiments where the seal layer has a higher RI than the lenses, the uncured lens material may be embossed to create a plurality of concave lenses.

In some embodiments, subsequent to embossing, the uncured and doped lens material is bathed in actinic radiation (for example, ultraviolet light) to initiate curing and cross-linking of the resin. Depending on the design, and whether a seal layer is specified by the design, a further layer of transparent material may be applied on top of the lenses.

According to various embodiments, operations 205-215 produce a micro-optic security device which has a characteristic machine-readable signal that is detectable on both quality control equipment, which typically output a pass-fail signal, and production equipment, such as used by the U.S. Bureau of Engraving, and which output a qualitative measurement of signal strength, with a band of intermediate values indicating “pass” and the upper (i.e., saturated signal) and lower tails of the response curve indicating either failure or excess doping.

As noted elsewhere in this disclosure, by doping the upper layers (i.e., the lens layer) of the micro-optic system with an optically neutral, machine-readable compound, certain embodiments according to the present disclosure afford the technical benefit of providing reliable machine-readability in thicker (for example, greater than 70 microns in total thickness) micro-optic devices than can be achieved by applying the machine-readable component in a camo coat underneath the icon layer.

Examples of micro-optic devices according to certain embodiments of this disclosure include micro-optic devices which include an optical spacer having a first side and a second side, an icon layer comprising a plurality of image icons of a first color disposed on the first side of the optical spacer, and a focusing layer comprising a plurality of refractive focusing elements disposed on the second side of the optical spacer. The plurality of refractive focusing elements project a synthetically magnified image of the plurality of image icons, and image icons of the first color project a component of the synthetically magnified image that is of the first color. Additionally, the refractive focusing elements are doped with a machine readable taggant which emits a characteristic signal at a first frequency in the ultraviolet spectrum.

Examples of micro-optic devices according to certain embodiments of this disclosure include micro-optic devices wherein the machine readable taggant is a phosphorescent up-converter which absorbs light energy at a second frequency in the infrared spectrum.

Examples of micro-optic devices according to certain embodiments of this disclosure include micro-optic devices wherein the machine readable taggant is a strontium aluminate-based pigment.

Examples of micro-optic devices according to certain embodiments of this disclosure include micro-optic devices wherein the machine readable taggant is provided as a suspension in a radiation-curable polymer.

Examples of micro-optic devices according to certain embodiments of this disclosure include micro-optic devices wherein the machine taggant is provided at a concentration between 0.1-0.6% by weight of a mixture of taggant and radiation-curable polymer.

Examples of micro-optic devices according to certain embodiments of this disclosure include micro-optic devices comprising a surfactant to keep the machine-readable taggant suspended prior to curing.

Examples of micro-optic devices according to certain embodiments of this disclosure include micro-optic devices wherein the device does not comprise a background coating applied to the icon layer.

Examples of micro-optic devices according to certain embodiments of this disclosure include micro-optic devices wherein the micro-optic security device has a thickness of 75 microns or greater.

Examples of methods for making micro-optic devices according to various embodiments of this disclosure include methods comprising providing an optical spacer having a first side and a second side, forming an icon layer comprising a plurality of image icons of a first color on the first side of the optical spacer; and forming a focusing layer comprising a plurality of refractive focusing elements on the second side of the optical spacer, wherein the plurality of refractive focusing elements project a synthetically magnified image of the plurality of image icons, wherein image icons of the first color project a component of the synthetically magnified image that is of the first color, and wherein refractive focusing elements of the plurality of refractive focusing elements are doped with a machine readable taggant which emits a characteristic signal at a first frequency in the ultraviolet spectrum.

Examples of methods for making micro-optic devices according to various embodiments of this disclosure include methods wherein the machine readable taggant is a phosphorescent up-converter which absorbs light energy at a second frequency in the infrared spectrum.

Examples of methods for making micro-optic devices according to various embodiments of this disclosure include methods wherein the machine readable taggant is a strontium aluminate-based pigment.

Examples of methods for making micro-optic devices according to various embodiments of this disclosure include methods wherein the machine readable taggant is provided as a suspension in a radiation-curable polymer.

Examples of methods for making micro-optic devices according to various embodiments of this disclosure include methods wherein the machine taggant is provided at a concentration between 0.1-0.6% by weight of a mixture of taggant and radiation-curable polymer.

Examples of methods for making micro-optic devices according to various embodiments of this disclosure include methods further comprising adding a surfactant to keep the machine-readable taggant suspended prior to curing.

Examples of methods for making micro-optic devices according to various embodiments of this disclosure include methods wherein the device does not comprise a background coating applied to the icon layer.

Examples of methods for making micro-optic devices according to various embodiments of this disclosure include methods wherein the micro-optic security device has a thickness of 75 microns or greater.

Although the present disclosure has been described with various embodiments, various changes and modifications may be suggested to one skilled in the art. It is intended that the present disclosure encompass such changes and modifications as falling within the scope of the claims.

1. A micro-optic security device comprising:
an optical spacer having a first side and a second side;
an icon layer comprising a plurality of image icons of a first color disposed on the first side of the optical spacer; and
a focusing layer comprising a plurality of refractive focusing elements disposed on the second side of the optical spacer,
wherein the plurality of refractive focusing elements project a synthetically magnified image of the plurality of image icons,
wherein image icons of the first color project a component of the synthetically magnified image that is of the first color, and
wherein refractive focusing elements of the plurality of refractive focusing elements are doped with a machine-readable taggant which emits a characteristic signal at a first frequency in the ultraviolet spectrum.

2. The micro-optic security device of claim 1, wherein the machine-readable taggant is a phosphorescent up-converter which absorbs light energy at a second frequency in the infrared spectrum.

3. The micro-optic security device of claim 1, wherein the machine-readable taggant is a strontium aluminate-based pigment.

4. The micro-optic security device of claim 1, wherein the machine-readable taggant is provided as a suspension in a radiation-curable polymer.

5. The micro-optic security device of claim 4, wherein the machine-readable taggant is provided at a concentration between 0.1-0.6% by weight of a mixture of taggant and the radiation-curable polymer.

6. The micro-optic security device of claim 4, further comprising a surfactant to keep the machine-readable taggant suspended prior to curing.

7. The micro-optic security device of claim 1, wherein the device does not comprise a background coating applied to the icon layer.

8. The micro-optic security device of claim 1, wherein the micro-optic security device has a thickness of 75 microns or greater.

9. A method of making a micro-optic security device, the method comprising:
providing an optical spacer having a first side and a second side;
forming an icon layer comprising a plurality of image icons of a first color on the first side of the optical spacer; and
forming a focusing layer comprising a plurality of refractive focusing elements on the second side of the optical spacer,
wherein the plurality of refractive focusing elements project a synthetically magnified image of the plurality of image icons,
wherein image icons of the first color project a component of the synthetically magnified image that is of the first color, and
wherein refractive focusing elements of the plurality of refractive focusing elements are doped with a machine-readable taggant which emits a characteristic signal at a first frequency in the ultraviolet spectrum.

10. The method of claim 9, wherein the machine-readable taggant is a phosphorescent up-converter which absorbs light energy at a second frequency in the infrared spectrum.

11. The method of claim 9, wherein the machine-readable taggant is a strontium aluminate-based pigment.

12. The method of claim 9, wherein the machine-readable taggant is provided as a suspension in a radiation-curable polymer.

13. The method of claim 12, wherein the machine-readable taggant is provided at a concentration between 0.1-0.6% by weight of a mixture of taggant and the radiation-curable polymer.

14. The method of claim 12, further comprising adding a surfactant to keep the machine-readable taggant suspended prior to curing.

15. The method of claim 9, wherein the device does not comprise a background coating applied to the icon layer.

16. The method of claim 9, wherein the micro-optic security device has a thickness of 75 microns or greater.
